(19) United States
(12) Patent Application Publication
(10) Pub. No.: US 2012/0314827 A1
(43) Pub. Date: Dec. 13, 2012

(54) System for Active Long Range Detection and Identification of Special Nuclear Materials Using a High Intensity Particle Beam

(75) Inventors: Istvan Dioszegi, Middle Island, NY (US); Leon Forman, Miller Place, NY (US); Peter E. Vanier, Setauket, NY (US); Cynthia A. Salwen, Center Moriches, NY (US)

(73) Assignee: Brookhaven Science Associates, LLC, Upton, NY (US)

(21) Appl. No.: 13/481,988

(22) Filed: May 29, 2012

Related U.S. Application Data
(60) Provisional application No. 61/490,292, filed on May 26, 2011.

(51) Int. Cl. G21G 1/00

(52) U.S. Cl. 376/156

(57) ABSTRACT

A long-range method and a system for reliably detecting and identifying special nuclear materials is provided that relies on the emission of delayed neutrons present in the decay of fission products (delayed neutron precursors) as a unique signature for the special nuclear materials, such as highly enriched uranium (^{235/238}U). The method relies on a time-of-flight measurement in the first 1 μs after the inducing radiation pulse, and pulse height data analysis for both neutrons and gamma rays that can be done at a much higher data rate than in traditional pulse processing systems. The thermal neutron fission within the time regime of 100-500 μs provides a unique signature of special nuclear materials such as the highly enriched uranium.

### CROSS-REFERENCE TO A RELATED APPLICATION

This application claims the benefit under 35 U.S.C. 119(e) of U.S. Provisional Application No. 61/490,292 filed on May 26, 2011, the content of which is incorporated herein in its entirety.

### STATEMENT OF GOVERNMENT LICENSE RIGHTS

The present invention was made with Government support under contract number DE-AC02-98CH10886, awarded by the U.S. Department of Energy, and contract number IACRO 09-46641 by the U.S. Department of Defense. The government has certain rights in the invention.

### FIELD OF THE INVENTION

This invention relates to the field of long range active interrogation of special nuclear materials, such as highly enriched uranium (HEU). In particular, the invention relates to inducing fission in targets by high energy particles or photons and identifying fission product signature(s) for the special nuclear materials based on thermal neutron multiplication.

### BACKGROUND

Long range detection and identification of special nuclear materials (SNM) is an important goal for nuclear nonproliferation, national security and nuclear safeguards. As defined by Title I of the Atomic Energy Act of 1954, special nuclear materials include plutonium, uranium-233, or uranium-238 enriched with uranium-233 or uranium-235 isotopes. In concentrated form the special nuclear materials can be the primary ingredients of nuclear explosives. In fact, the uranium-235 content of natural uranium can be concentrated, i.e., enriched, to make highly enriched uranium (HEU), which is the primary ingredient of an atomic bomb.

Historically, many of the tools used to safeguard SNMs have relied on measuring one or more of the inherent nuclear attributes or signatures of these SNMs. Some of these attributes or signatures include (i) spontaneous fission, (ii) susceptibility to undergo fission following neutron absorption, (iii) the emission of high energy alpha (α) particles, which can generate neutrons through (α,n) reactions, and (iv) the emission of both low and higher energy gamma (γ) rays. The presence of interferences, such as shielding and other high-Z profile materials, however, may influence these attributes or signatures to the degree that many of the historical tools and techniques used in nuclear safeguards must be modified or redesigned to be able to provide specificity in the presence of interference.

Active interrogation techniques, which use external radiation sources to excite nuclear processes in materials, may help in addressing these challenges. In particular, active interrogation amplifies inherently weak signatures. By using pulsed radiation fields to stimulate fissionable material, active interrogation can, furthermore, investigate time-correlated signatures, which passive signature techniques generally cannot by monitoring the induced radiation with appropriate nuclear detectors. Active interrogation, as a tool for nuclear safeguards and process monitoring in the nuclear fuel manufacturing and recycling, has been the subject of many research projects summarized in Gozani, T., “Active Nondestructive Assay of Nuclear Materials,” Report NUREG/CR-0602,” U.S. Nuclear Regulatory Commission, Washington, D.C., (1981); which is incorporated herein by reference in its entirety.

Active interrogation monitoring techniques, however, have not seen widespread application in today's fuel reprocessing facilities, because alternate technologies have been found to achieve the same goals. Moreover, active interrogation techniques are typically more complicated and more expensive than comparable passive techniques. Yet, because active interrogation measurements can be performed without contacting SNMs, active interrogation is an ideal solution for performing on-line monitoring in areas where the SNMs may be hazardous or difficult to contain, and where the consequences of spills and contamination are high. Also, since active interrogation measurements can be made without contacting SNMs directly, instrumentation maintenance and repair can be performed without the need to break into the SNM containers or impact subsequent operations.

While a number of active interrogation techniques are available, such as the irradiated fuel assay, leached cladding hulls analysis, and process monitoring, the available techniques take an unacceptably long time to obtain reliable data, which can be on the order of several minutes. (D. L. Chichester & E. H. Seabury, “Active Interrogation Using Electronic Neutron Generators for Nuclear Safeguards Applications,” INL/CON-08-14196, 2008; incorporated herein by reference in its entirety). Since in almost all scenarios of interest the target containing the SNMs is moving, for active interrogation to be useful, all the data must be obtained either in few or perhaps in only one interrogation pulse.

One of the techniques for performing active interrogation is to use neutron activation to generate high intensity radiation probes. While, the special nuclear materials, such as uranium-233, uranium-235, and plutonium-239, are only mildly radioactive, neutron activation can induce radioactivity by fission in the target containing special nuclear materials by exciting atomic nuclei within the target. The excited nuclei are subsequently relaxed by emitting subatomic particles and γ-radiation. Appropriate detection of the neutrons and γ-radiation and analysis of the detected spectrum facilitates the identification of a particular substance within the designated location of the target material.

Scintillation detectors such as a sodium iodide (NaI) scintillator coupled with a photomultiplier tube (PMT) have been proposed and used for detecting the γ-radiation induced from the target material by the neutron activation. However, despite the availability of such technique, it suffers from numerous drawbacks. While scintillation detectors are known to have fast response times, which can be on the order of nanoseconds with relatively simple structure, they exhibit poor energy resolution of y-radiation. Such poor energy resolution of y-radiation causes, inter alia, a loss of information. That is because γ emissions from different isotopes of the target material that have similar γ energy spectrums cannot be properly separated. For example, the γ energy spectrum for a relatively benign fission material ²³⁸U is very similar to the highly enriched fission material ²³⁵U/²³⁸U. Moreover, in applying the high intensity radiation probes, the data rate required to analyze the nuclear return signal in the prompt region defined by 100 μs-10 ms, i.e., is beyond the capability of standard analytical tools.

Thus, it is desirable to have an active interrogation system that can separate the signal of the special nuclear materials from relatively benign fission material with high-Z value when the induced fission is used. It is also desirable to have a system with the data rate sufficient to analyze the nuclear return signal in the prompt region defined by 100 μs-10 ms.

### SUMMARY

A method for reliably detecting and identifying special nuclear materials is provided. The method relies both on the emission of fast neutrons that create nuclear reactions in bulk media and on the emission of delayed neutrons and gamma rays present in the decay of fission products as unique signature(s) for the special nuclear materials. The emission of delayed neutrons is detected by radiation measurements preceding the β-decay of the delayed neutron precursor fission products that begins 100 μs after the generation of the fission-inducing radiation pulse. Preferably, the disclosed method for detecting and identifying special nuclear materials has the steps of (i) exposing a target to a high intensity particle or photon beam pulse to induce fission; (ii) detecting emission of prompt and delayed radiation from the target using a detection system including fast and thermal neutrons; (iii) recording fast neutrons induced by thermal neutron fission and gamma-rays from thermal neutron induced fission; (iv) analyzing a die away in the fast neutron yield induced by thermal neutron fission of the target; and (iv) comparing the fast neutron yield from the target to the fast neutron yield characteristic for a special nuclear material; where a close correlation of the fast neutron die away indicates the presence of the special nuclear material within the target. The die away yield of fast neutrons are recorded in the 100-500 μs time region after the induced fission, and preferably in the 150-450 μs time region after the induced fission. A detection system to carry out the disclosed method is also provided. The system affords a pulse height data analysis for both neutrons and gamma rays at a much higher data rate than in traditional pulse processing systems

It is within the bounds of the disclosed embodiments that the SNMs can be scanned, monitored or identified either within a short- or long-range distance between the target and the detection system. In the preferred embodiment, however, the method is used in the long-range active interrogation of highly enriched uranium (^{235/238}U) The long-range implies the distance between the target and the detection system of 10 m to 200 m, and preferably, 20 m to 50 m.

The method includes exposing a target to a short high intensity particle beam pulse to induce neutron fission. The pulse can come from high energy proton sources, photon (bremsstrahlung) sources, or any other similar sources known to induce neutron fission. If the pulse comes from the high energy proton source, the pulse is, preferably of <10⁻⁷ sec in duration and intensity of 10¹² for about 100 m interrogation distance and 10¹⁰ protons for about 10 m distance. If the pulse comes from photon (bremsstrahlung) source, the duration is in the range of <10-7 sec and the radiation dose at ˜8 m distance is ˜20 rad.

The method further includes detecting emission of neutrons generated by the reactions in the target and separated by time of flight (TOF) measurement. The signatures of reaction neutrons can occur in the 100 ns-2 μs region. The detection can be facilitated, but not limited to, a detection system having a sufficiently fast organic or inorganic scintillators optically coupled to a sufficiently fast photomultiplier tube operating in a low-gain mode capable of a very high count rate recording, and a recording system operably linked to the photomultiplier. The recording system is a high-bandwidth digitizer (e.g., digital oscilloscope).

The recording system of the disclosed detection system is designed to measure target reaction neutron output by time-of-flight and to determine the neutron and γ energy spectra by pulse height analysis. The recording bandwidth of the recording system is greater than 100 MHz, which is considerably faster than standard pulse analysis systems of the prior art. In the preferred embodiment, the recording bandwidth is between 100 MHz and 500 MHz. The present system allows γ ray analysis of the isomeric states of the reactant products to further differentiate bombarded targets in addition to the delayed neutron measurements.

The method for reliably detecting and identifying special nuclear materials further includes monitoring for thermal neutron induced fast neutron production that occurs hundreds of microseconds after the interrogating pulse by pulse height discrimination, and comparing the fast neutron yield from the target to the fast neutron yield characteristic for a special nuclear material. Based on this comparison, a die-away characteristics of the fast neutron yield indicates the presence of the special nuclear material within the target. An off-line, software based pulse shape discrimination can be used to separate the fast neutron yield from recorded mixed neutron and γ-ray pulses (G. F. Knoll, “Radiation Detection and Measurement” (3rd ed.), John Wiley & Sons Inc., New York (2000) pp. 679-680; incorporated herein by reference in its entirety). Typically, the system operates in the time regime of 100-5000 μs, which is associated with thermal neutrons produced in the target. The thermal neutron fission within the time regime of 100-500 μs provides a unique signature of special nuclear materials such as the highly enriched uranium.

These and other characteristics of the method for reliably detecting and identifying special nuclear materials and the system to carry out the method will become more apparent from the following description and illustrative embodiments which are described in detail with reference to the accompanying drawings. Similar elements in each figure are designated by like reference numbers and, hence, subsequent detailed descriptions thereof may be omitted for brevity.

### BRIEF DESCRIPTION OF THE DRAWINGS

FIG. 1 is a schematic of a photomultiplier (PM) power system modified to operate in the gain management configuration. Changes from the normal operation are shown in black, where the transient signal is taken off the third dynode and the added capacitors for the last stages are optimized for recovery from initial proton flash transient.

FIG. 2 is a plot of a PM pulse height for Compton edge of Co-60 versus high voltage.

FIG. 3 is an oscilloscope background spectrum taken at AGS and Mercury with a 200 ms trace length from the initial flash.

FIG. 4 is a time-of-flight neutron signal from a U-235 target, which was set at 12 m from the detector (the neutron pulse is located about 500 ns after the onset of the proton flash).

FIG. 5 is a plot that shows an example of data set recorded by a digital oscilloscope. In the inset, individual detected pulses are separated at a count rate of 2×10⁶ counts/s.

FIG. 6 is a plot that shows relative gain of the PM after the proton flash.

FIG. 7 is a normalized neutron spectrum of 4 GeV/c protons bombarding U-235 and from spontaneous fission of Cf-252.

FIG. 8 is a plot that shows neutrons and gamma rays separated by the slower decay time of the neutron pulse.

FIG. 9 is a gamma (γ)-ray spectrum of different targets irradiated by 4 GeV proton irradiations taken 350 μs after the proton flash in a 10 μs wide time window.

FIG. 10 is a plot that shows a signal for various targets located 20 m from the detector.

FIG. 11 is a plot that shows detected average baseline shifts for depleted uranium (DU) surrounded by pure and boron loaded polyethylene.

FIG. 12 is a plot that shows Monte Carlo (MCNPX) calculation of fast neutron and thermal neutron yields as a function of time for shielded highly enriched uranium (HEU).

### DETAILED DESCRIPTION

A method for reliably detecting and identifying special nuclear materials and a detection system to carry out this active interrogation are provided. A fundamental problem in identifying special nuclear material (SNM) is that induced fission may occur in high-Z targets that are not special nuclear materials, for instance depleted uranium (²³⁸U). In contrast, all special nuclear materials have high neutron fission cross sections as opposed to other heavy elements (²³⁸U, ²³²Th, etc.) The method measures induced fission produced fast neutrons, thermal neutrons, isomeric states of fission fragments and gamma-ray emission from neutrons interacting in bulk media to reliably detect and identify special nuclear materials even in presence with other high-Z materials. The method enables neutron/gamma ray spectral analysis from active single pulse interrogation sources in the early time range of about 10 μs to about 1 s. The thermal neutron fission within the time regime of 100-500 μs provides a unique signature of special nuclear materials such as the highly enriched uranium.

Application of pulsed beams is superior to direct current, because the time-of-flight (TOF) of the particles contains valuable information on the nature and energy of the radiation. Application of a single energetic pulse has preferable peak to background conditions, but suffers from the fact that the intensity of the induced radiation quickly falls, thus resulting in poor statistics in the pulse counting measurement. In contrast, in the first millisecond the high intensity of the radiations (˜10³ neutron counts in 100 ns, i.e. 10¹⁰ Hz) blinds the detectors and saturates the counting electronics. In this first millisecond time, however, there is a large amount of valuable information, which is normally lost, because the high intensity saturates the detector. The neutron TOF spectra in this first millisecond, however, can identify neutron sources and their distance. If there is a moderator around the fissionable target material, the moderator will create thermal neutrons, which are multiplied in the special nuclear material (SNM), bearing a unique signature in case of Highly Enriched Uranium (HEU) or Depleted Uranium (DU).

The gamma ray spectrum contains significant radiation lines that can identify target materials e.g. 2.2 MeV photons from thermal neutron capture from hydrogen. The die away of the fast neutrons (and consequently the hydrogen line) may differentiate HEU from DU. In principle the die away of the neutrons and gamma rays, and their relative intensities can be used to determine the multiplication constant of SNM carrying targets.

Preferably, the method includes exposing a target to a short high intensity particle beam pulse to induce neutron fission. The pulse can come from high energy proton sources, photon (bremsstrahlung) sources, or any other similar sources known to induce neutron fission, as long as the pulse has the required parameters, preferably of <10⁻⁷ sec in duration and intensity of 10¹² for 100 m interrogation distance and 10¹⁰ protons for ˜10 m distance. For bremsstrahlung pulses the duration is in the range of <10-7 sec and the radiation dose at ˜8 m distance is ˜20 rad.

A high energy proton pulse will also produce spallation and fission in a target (although the fission probability becomes very low for Z<80). Fast neutrons produced by the proton flash undergo fast multiplication as they traverse fissionable material in the target. This occurs in all materials whose fission threshold is above 1.5 MeV (e.g. U-238). A fraction of the neutrons is typically thermalized in surrounding media. Thermal neutrons can cause thermal neutron fission in SNM. Fast neutrons from thermal fission have a fast multiplication as well as the thermal fission multiplication. Times of interest are that fast multiplication takes place in couple of μs, thermal neutron fission occurs in 100's of μs, delayed neutron half-lives are from 0.1 s-1 min.

When considering a multiplying media with N_{T} neutrons produced by proton bombardment, a fast neutron multiplication of M_{f}, a probability of thermal fission Pₜ, a fraction of the total neutrons thermalized entering the media of fₜₕ, a thermal neutron multiplication factor of Mₜₕ, a number of delayed neutrons from delayed neutron precursors of N_{d}, and then N_{ft} and N_{fd} are the number of fast neutrons that can be detected:

N_{ft}=N_{T}fₜₕPₜ(M_{f}+Mₜₕ)Thermal neutron production(50-1000 usec)

N_{fd}=N_{d}(M_{f})+N_{d}fₜₕPₜ(M_{f}+Mₜₕ)Time>1 sec

where:
Pt→1 for Pu-239, U-235
Pt→0 for U-238, Th-232
N_{T}/N_{d}≈100

In principle, these factors give an overwhelming advantage for the thermal neutron production approach for fₜₕ>0.1. This advantage grows when N_{T} may include contributions of all materials by spallation, whereas N_{d} only depends on production of the long lived delayed neutron precursors. These advantages are limited by the fact that the scintillator responds to both gamma rays and fast neutrons. The gamma ray population may have a 2:1 advantage for fission, have a contribution from the targets isomeric states of fission and spallation products, and have a contribution from thermal neutron capture by all materials in the target. Additionally, the interaction probability for 2 MeV neutrons in the scintillator may be 3 times higher than for 2 MeV photons. A detector shield of 5 cm lead would preferentially transmit neutrons by a factor of 3.

In a preferred embodiment, the short high intensity particle beam pulse is a single proton pulse of duration less than 100 ns that contains at least 10¹¹ protons. While the method is not limited to a short- or long-range detection and can be successfully applied to either one, in the preferred embodiment, however, the method is used in the long-range active interrogation of highly enriched uranium (^{235/238}U) The long-range implies the distance between the target and the detection system of 10 m to 200 m, and preferably, 20 m to 50 m.

The disclosed method further includes detecting emission of neutrons by neutron interaction with bulk media from the fission decay of the target. Neutrons created by the flash can undergo elastic and inelastic scattering, neutron capture, fission (resulting multiplication), and many other reactions until they leave the target. The process of neutrons leaving the target is referred to as die-away and in a target of tens of cm in size, fast neutron die-away has mean times of the order of microseconds. Those neutrons that come to thermal equilibrium in the target will flow out by diffusion in time over 100 microseconds. Thermal neutrons in the target may undergo capture or fission (all thermal neutron fissionable materials are of high interest). Table 1 illustrates minimum bandwidth (Hz) required to record die-away reactions for gamma ray and neutron detectors.

TABLE 1

| Time after pulse (μsec) | Minimum bandwidth (Hz) |
|---|---|
| 10 | 10⁸ |
| 100 | 10⁷ |
| 1000 | 10⁶ |
| 10000 | 10⁵ |

Using the disclosed method, the signatures of delayed neutrons occur in the 0.1-600 μs time region. The detection can be facilitated by a detection system having a scintillator optically coupled to photomultiplier operating in a low-gain mode. The scintillator can be a sufficiently fast organic or inorganic scintillator, capable to resolve pulses at ˜100 MHz data rate. The photomultiplier is not specifically limited in the described method as long as it is a sufficiently fast photomultiplier capable of a very high (˜100 MHz) count rate recording. The photomultiplier is subsequently connected to a recording system that includes a high-bandwidth digitizer to record the signal.

The scintillator used in the disclosed detection system must be sufficiently fast to convert neutrons and gamma-rays into photons that are detected by the photomultiplier. In particular, the scintillator should have a rise time of less than 1 ns and an exponential decay constant of 2-20 ns, preferably 5 ns. In addition, besides the efficiency of conversion of neutrons and gamma-rays into photons, the response of the scintillator depends on the transit time of the neutrons and gamma-rays across the thickness of the scintillator. In a preferred embodiment, the scintillator is a liquid organic scintillator, e.g., Bicron® BC-501A, intended for neutron detection in the presence of gamma radiation. The liquid scintillators have good particle discrimination capability. In an organic scintillator the corresponding scintillation pulse may be described by a sum of two exponential time-dependent components. One component is termed “fast” and the other component “slow”. These two components are weighted differently depending on the excitation induced by particles of different types. While, neutrons interact with the scintillating medium through the process of proton recoil, gamma-rays are primarily detected through Compton electron recoil. The scintillation response for electron ionization is faster than the response for proton ionization. This type of scintillation response is commonly used as a means of suppressing gamma-ray background in neutron detection systems.

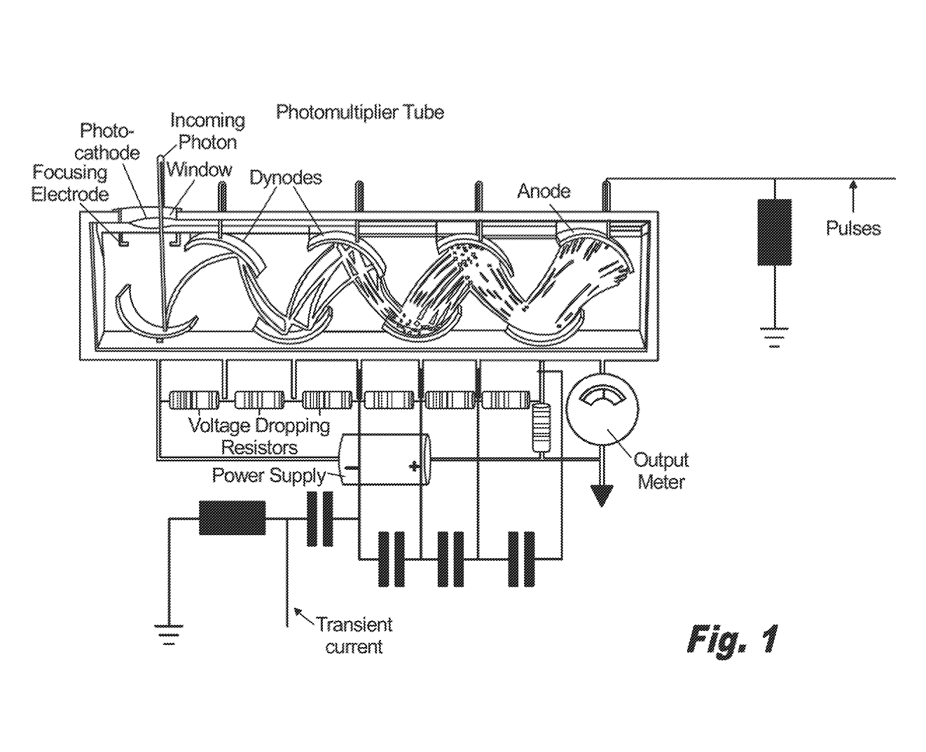

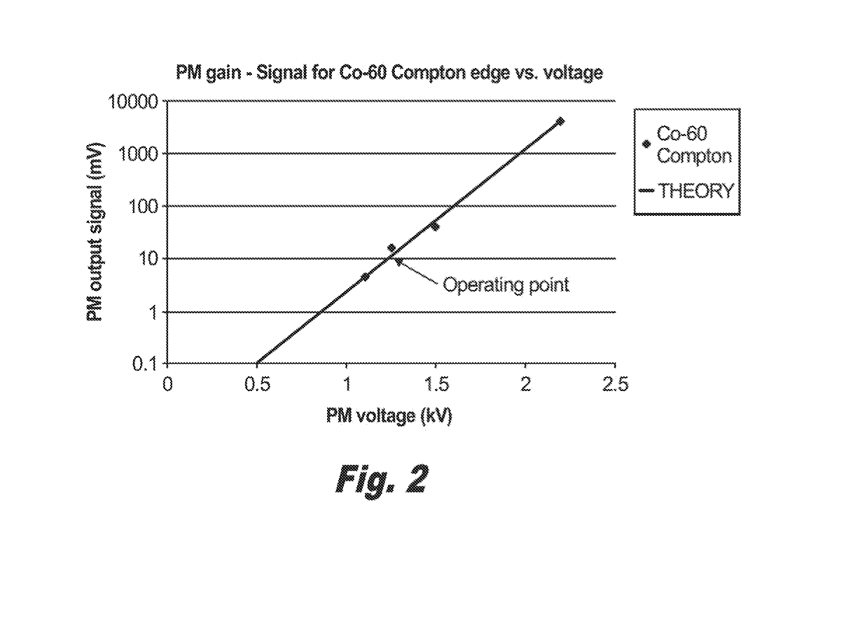

The photomultiplier employed in the disclosed detection system is optically coupled to the scintillator. Typically, a head-on type photomultiplier, such as Bicron, Model 5MAB-1F2BC501A/2-X or 2MAB-1F1BC501A/2-X, can be used with low-level light sources. The radiation pulse time response of these fast photomultiplier/scintillators makes it possible to record high count rates, 10⁷ counts/second. However, these devices are normally count rate limited by the rate of charge replenishment through the bleeder string that supplies the photo multiplier (PM) dynode structure. Initially, the detector output signal, as measured at the anode of the photomultiplier, reaches the saturation voltage or the highest voltage the anode circuit can deliver. Moreover, the high current in all the later dynodes draws charge from its capacitance storage at a rate not replaceable by the bleeder string. This causes a gain reduction that is fixed until charge replacement occurs from the high voltage supply through the bleeder string. In contrast, the photomultiplier can be operated at low gain, where the charge per particle may be a factor between 1/100 to 1/10000, although preferably with 1/1000, or lower (see FIG. 2 for ⁶⁰Co) Under low gain, the inter-dynode charge can be replaced between particles. The neutron current signal is usually quite low and there is no evidence that it further discharges the photomultiplier dynode structure. However, at the lower gain the charge load for the high current transient of the proton flash and neutron TOF signals is lower. Thus, as illustrated in FIG. 1, external capacitors are required to minimize the charge drain in the later dynode stages. In the preferred embodiment, the recovery of gain can occur about 150 μs after the proton flash.

While energized, photomultipliers must be shielded from background neutron radiation to prevent their destruction through overexcitation. If used in a location with strong magnetic fields, photomultipliers can be shielded by a layer of mu-metal, i.e., nickel-iron alloy, lead, cadmium or a combination thereof. The strong magnetic field can curve electron paths, steer the electrons away from the dynodes and cause loss of gain. Such magnetic shielding is often maintained at cathode potential. Preferably, the external shield is electrically insulated because of the high voltage applied to the shield. While the photomultiplier used in the disclosed system can be used without shielding, photomultipliers with large distances between the photocathode and the first dynode are especially sensitive to magnetic fields and the shielding would typically be required.

If the neutrons travel to the photomultiplier/scintillators without collisions, the neutron spectra can be measured using the time-of-flight technique. The arrival time at the detector corresponds to the energy of the neutron and typically follows the proton flash after about 0.1-1.0 μs. The photomultiplier gain during the neutron time-of-flight signal can be estimated from the photomultiplier recovery signal. The neutron time-of-flight signal is in agreement with the neutron spectra derived from the cross-section measurement data using the estimated gain.

After gain recovery, analysis of the recorded data can be performed by counting pulses within a chosen time and amplitude window. Pulse height can be converted into deposited gamma-ray energy based on ⁶⁰Co calibration.

The recording system of the disclosed detection system is designed to measure target prompt neutron output by time-of-flight and to determine the neutron and γ energy spectra by pulse height analysis. The recording system has a high-bandwidth digitizer. The recording bandwidth of the digitizer is >100 MHz, which is considerably faster than standard pulse analysis systems of the prior art. Preferably, the bandwidth ranges between about 100 MHz and about 600 MHz. More preferably, the bandwidth ranges between about 100 MHz and about 400 MHz. The disclosed system allows γ ray analysis of the isomeric states of the reactant products to differentiate bombarded targets when added to the delayed neutron measurements. The system operates in the time regime associated with thermal neutrons produced in the target, 100-500 μs and measures any thermal neutron fission by pulse height discrimination.

Thus, the disclosed method for reliably detecting and identifying special nuclear materials, further includes monitoring for a fast neutron yield after the induced fission; and comparing the fast neutron yield from the target to the fast neutron yield characteristic for a special nuclear material. Based on this comparison, a close correlation of the fast neutron yield indicates the presence of the special nuclear material within the target. In a preferred embodiment, in order to separate the fast neutron yield from recorded mixed neutron and y-ray pulses, an off-line pulse shape software analysis is used.

### EXAMPLES

The examples set forth below also serve to provide further appreciation of the invention but are not meant in any way to restrict the scope of the invention.

### Example 1

A series of targets were exposed to single 4 GeV proton pulse of duration <100 ns containing 10¹¹ protons at Brookhaven National Laboratory's (BNL) Alternate Gradient Synchrotron Facility (AGS). The prompt gamma and neutron radiation (see FIG. 1) was detected using a liquid organic scintillator (Bicron® 501A, 5 in. diameter×2 in. thickness) optically coupled to a photomultiplier. The gain of photomultiplier was set to be about 10⁻³ of normal high gain. (At high gain the ⁶⁰Co produced a signal of ˜5V in the photomultiplier, at the reduced gain this was reduced to 10 mV). The data from the photomultiplier was detected using a 500 MHz digital recording system (Tektronix DPO7054 Digital Phosphor Oscilloscope) in direct current mode. The digital recording system operated in an automatic external trigger mode. The trigger was provided by the accelerator (AGS or Mercury) before the pulse arrival at the target. The digital recording system started to record about 3 ms prior the arrival of the first radiation, and continued recording for up to 80 ms. The time resolution was 10 ns over a 200 ms recorded time range. At the end of recording, the data were automatically written from the digital recording system memory to the hard drive as a waveform file using Tektronix proprietary utility software. The recorded waveform data was read and displayed Tektronix supplied LabVIEW-based software utility. The Tektronix supplied LabVIEW-based software utility was internally modified to enable selection of regions to analyze the waveforms. The modified program also enabled saving the data for time regions and converting the waveform data into a file that could be imported by Microsoft Excel for further analysis.

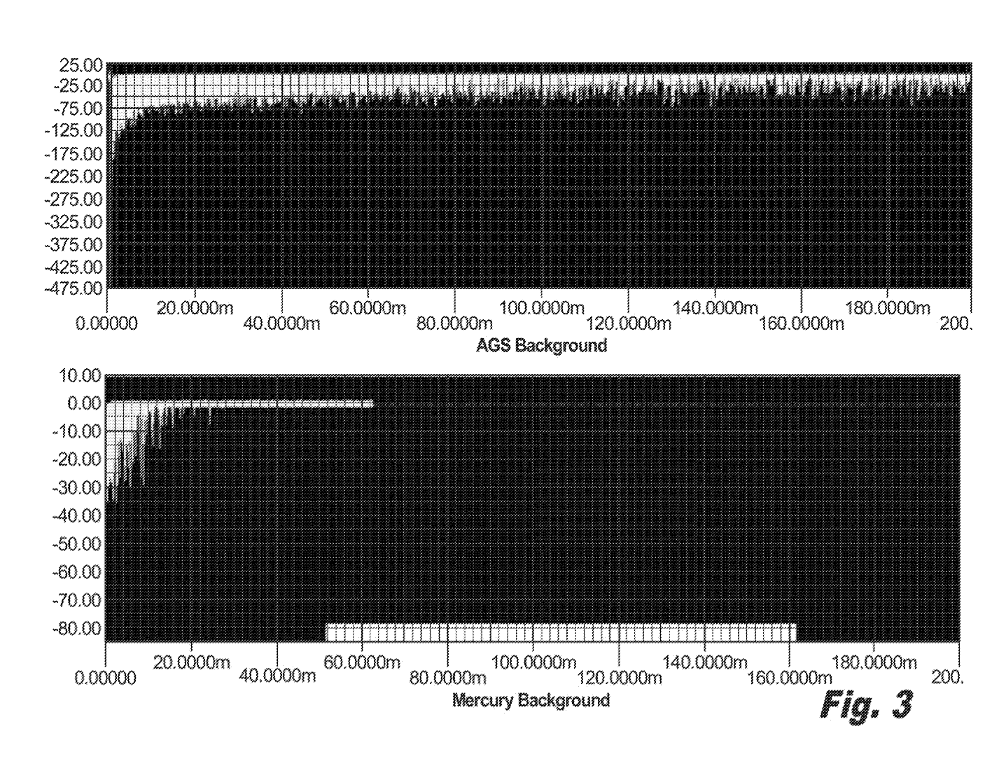

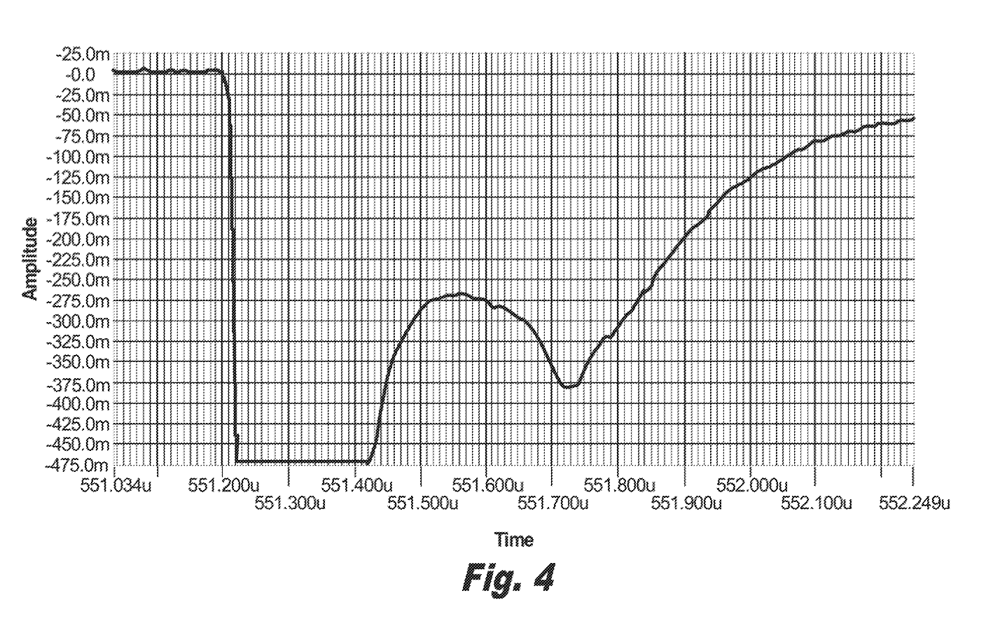

FIG. 3 displays background (no target) data for the two experiments. The radiation was detected 30 m from 4 GeV protons beam stop at the AGS and 8 m from the Mercury wall (Mercury Facility at Naval Research Laboratory, NRL, Washington, D.C.). The detected AGS intensity was 20 times higher at 3 ms time from the pulse and 1000 times higher at 20 ms. The relatively higher AGS gamma emission at longer times is attributed to 4 GeV proton induced direct and spallation reaction products. FIG. 4 shows the recorded data for the proton experiment using uranium target. Early on, the count rate is so high that individual pulses add together to an analog pulse. Signal starts with proton induced high velocity particles (e.g. gamma rays) traveling substantial distance to the detector (˜40 ns). The peak neutron signal occurs about 600 ns after the proton flash, corresponding to about 2.6 MeV neutron energy.

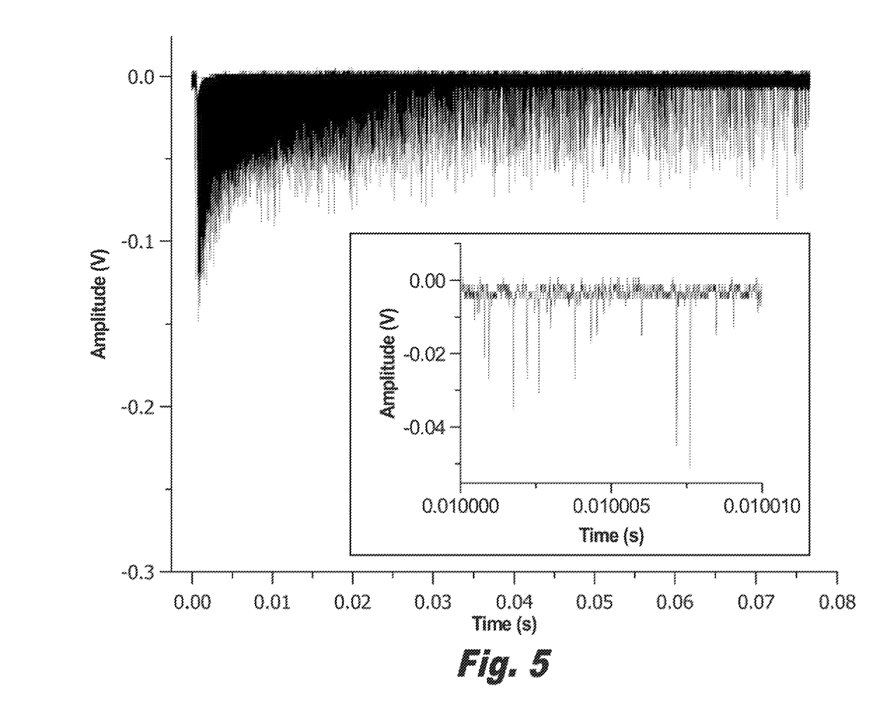

FIG. 5 displays a full recorded data set from 0 to 200 ms at 10 ns resolution. The inset in FIG. 5 shows a 10 μs long section of the recorded data at higher optical resolution (the display resolution is not high enough to see the individual peaks on the figure, the inset is just an enlarged part, where individual peaks are visible). At 2×10⁶ counts/s, the recording resolution permits separation of radiation pulses and at low gain the baseline noise is not very important. The full width at half maximum (FWHM) of the gamma-ray pulses was 15 ns. From the pulse height distribution, the gamma-ray energy spectra are derived as a function of time from the proton flash.

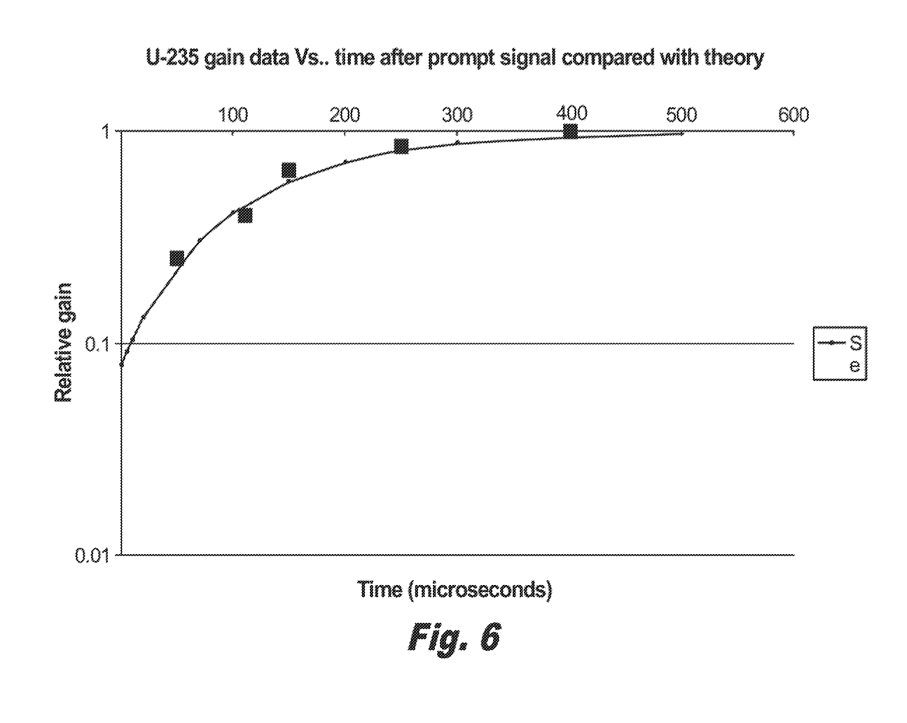

Gain can be determined as a function of time after the proton flash from the data. For U-235, the gain recovery is given in FIG. 6. “Theoretical” curve is from a simple RC model of charge flow from the inter dynode capacitors providing current flow. Using the calibration and early gain of about 0.1 in FIG. 6, the (overlapping) neutron pulse in FIG. 4 contains about 10⁵ 2-MeV neutrons. The total neutron pulse width in FIG. 3 is about 100 ns, so the neutron detection rate is about 10¹² pulses/sec.

### Example 2

The U-235 TOF data can be reduced using equation (1) when the number of individual detection pulses is large. The detected current I_{d}(tof) as a function of neutron time-of-flight is given by:

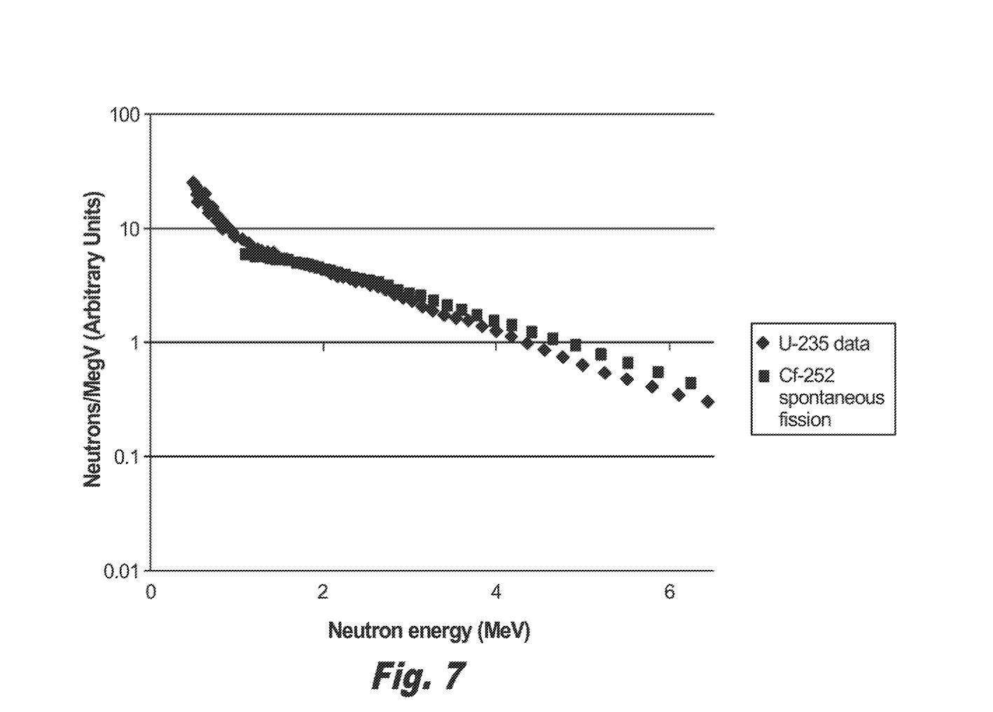

I_{d}(tof)dt=Sₒ(tof)dt T(D)X(Eₙ)q(Eₙ/2)G(Q), (1)

where for rapid neutron production in the target, Sₒ(tof) is the number of source neutrons/sec at distance D, T(D) is the fraction that reach the detector at distance D, X(Eₙ) is the scintillator interaction probability for a neutron of energy Eₙ, q(Eₙ/2) is the charge at the photocathode for the average proton energy deposited in the scintillator, and G(Qₜ) is the electrical gain measured from photocathode to the PM output and is set by the inter-dynode charge Qₜ. At later times, the gain of the PM recovers from charge depletion and individual pulses are recorded as illustrated in FIG. 5. The relative gain for neutrons over the 1 microsecond TOF data is about 0.08. FIG. 7 shows the results as compared with a normalized measurement on Cf-252 using the associated particle technique. The agreement suggests that the production of neutrons in both high energy proton irradiation of U-235 and spontaneous fission of Cf-252 can be described by the Maxwellian distribution of similar kinetic temperatures, ≈1.4 MeV.

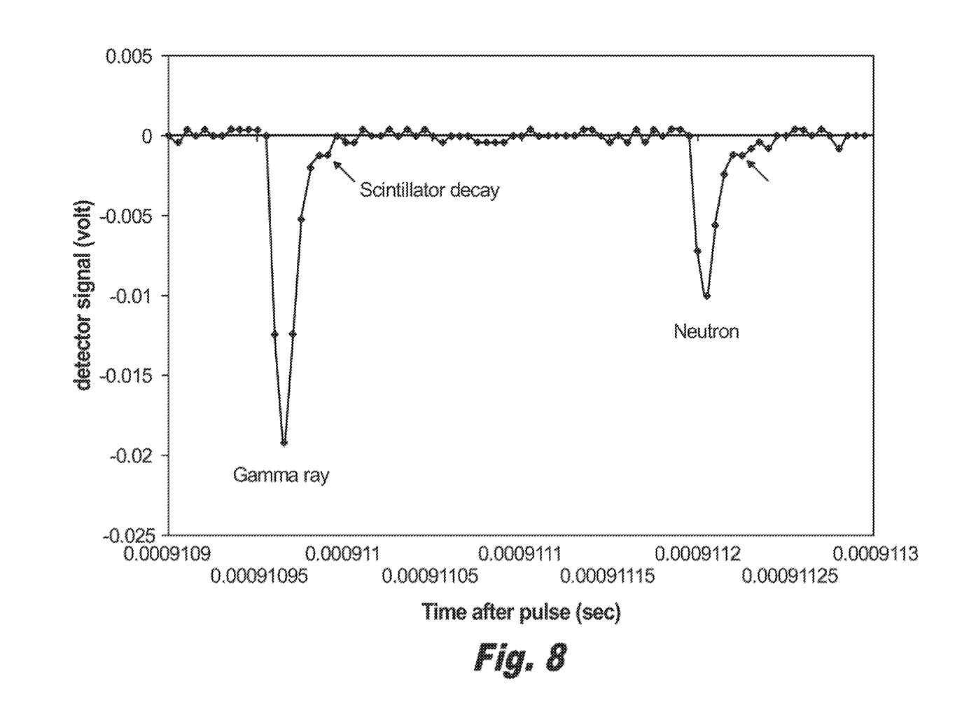

It may appear as though individual pulses in FIG. 7 are not resolved, but this is an artifact of photographic reproduction. The oscilloscope time setting was 10 ns. FIG. 8 shows that the recording resolution gives separable radiation pulses and that baseline noise is not very important at 5×10⁶ counts/sec. The full width at half maximum of the gamma pulses was 15 ns measured at calibration with Co-60. FIG. 8 also demonstrates the pulse shape difference for neutrons and gamma rays (higher tail for neutrons).

### Example 3

This example illustrates gamma-ray spectroscopic measurement by pulse height analysis of different targets with thickness of about 18 g/cm² that were irradiated by 4 GeV proton pulses. The detector was placed at 12 m distance upstream from the target. After the proton burst, the first large observable peak in the detector was mainly from prompt gamma radiation. After the prompt peak, the fast neutrons arrived at the detector. The fast neutrons were initially formed by either spallation, fission or multiplied chain reactions. After the prompt gamma radiation, the fast neutrons were detected within the <1 μs region. In the following 1 μs-0.2 s region, the gamma-ray emission from the isomeric states of the spallation/fission products dominated the spectrum. Although, the recorded time limit is 0.2 s, it is expected that β-decay of the products would be observable after that.

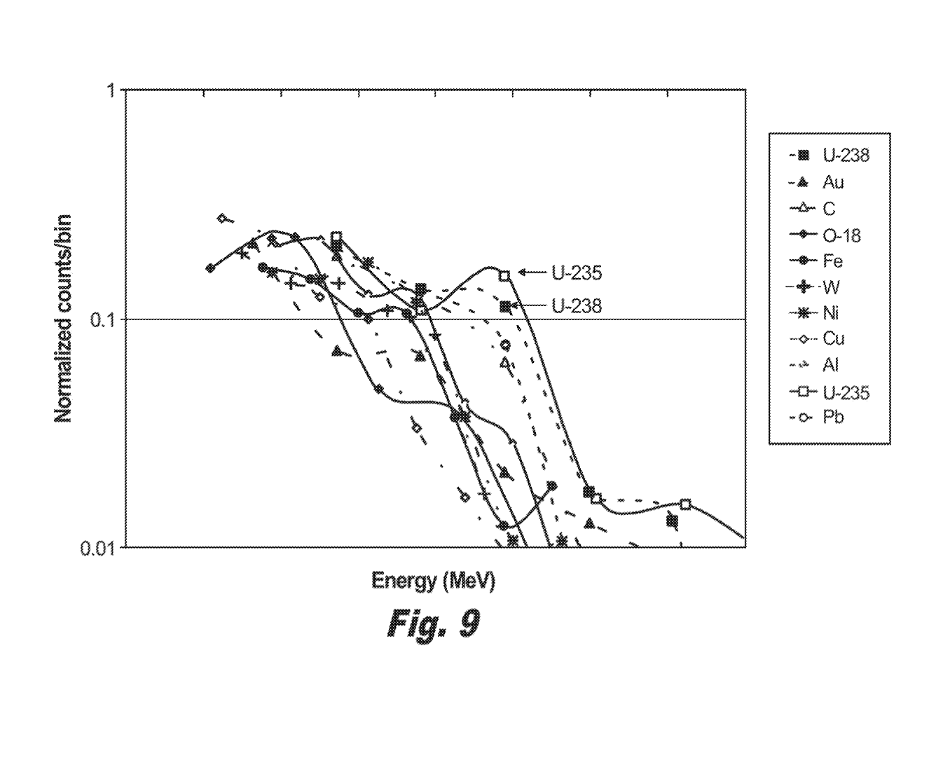

The isomeric transition region gamma-ray energy spectra of different targets was analyzed by placing 100 μs wide time windows and extracting the pulse height distribution within each window. An example of spectra where the 100 μs window was started 350 μs after the prompt burst is shown in FIG. 9. All cross-section targets (C, ¹⁸O, Al, Cu, Fe, Ni, Ti, Au, Pb, ²³⁵U, ²³⁸U) produced neutrons with spectra consistent with a Maxwellian kinetic temperature of the order 1.5 MeV. Furthermore, the liquid scintillator detector spectra are dominated by Compton scattering in the detector. The distinct observable feature is the Compton edge for each level. According to these measurements, the highest gamma-ray energies are emitted from the products of ^{235/238}U irradiation. However, the poor energy resolution of the liquid scintillator prevents the identification of the target based on the gamma-ray data in the 350-450 μs time region.

### Example 4

This example tests the ability of using the prompt recording technique, described in Example 3, to identify the depleted uranium targets in various shielding scenarios. The target containing a 20 kg cube of depleted uranium in various shielding configurations was placed at 10 or 20 m from the disclosed detector. The target was located in a tunnel, near the tunnel wall, where the beam passed 2 m from the detector on its way to the target assembly.

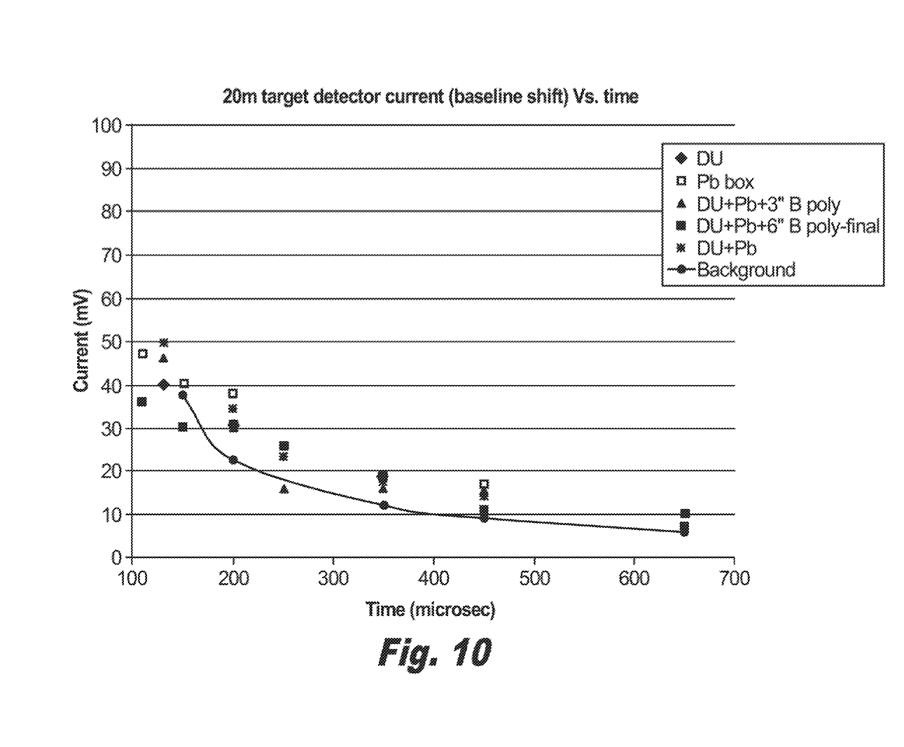

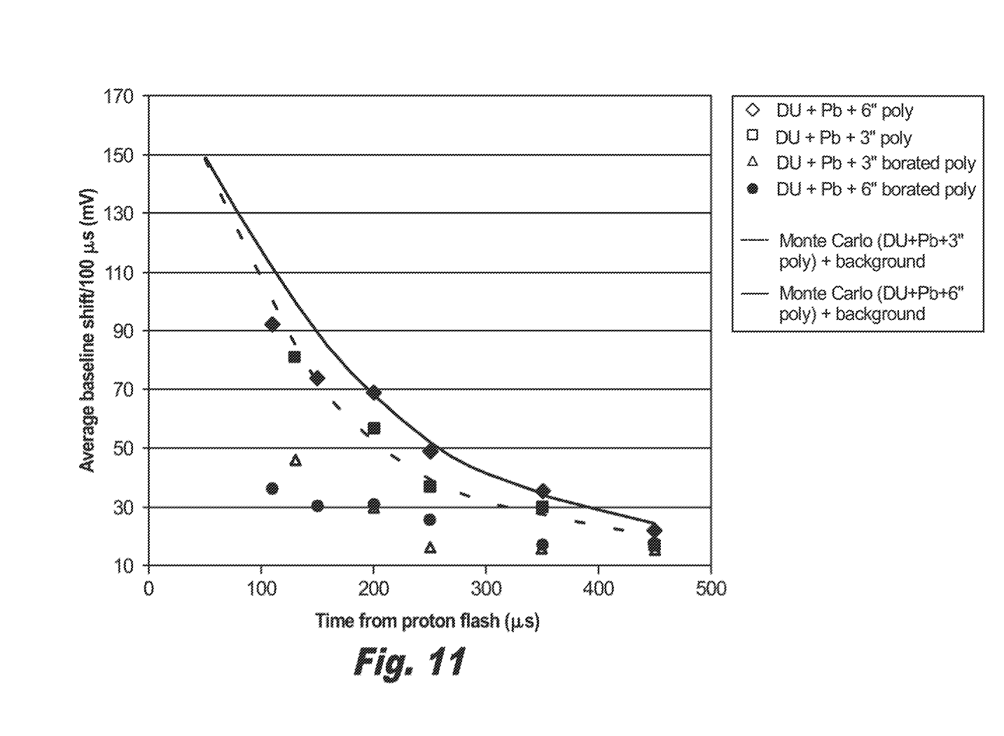

In this configuration the bulk target was surrounded by different neutron and gamma-ray shielding materials such as polyethylene, polyethylene with boron, steel and aluminum. The targets were located 20 meters from the detector, and data analysis was from measurement of the baseline shift. As illustrated in FIG. 10, there was no significant difference of the various target configurations relative to background where there was no target, although there was significant response generated from radiation hitting the area of the beam dump. The most important shielding effect was observed in targets with polyethylene shielding around depleted uranium, which showed an increased gamma-ray yield in the 100-500 μs time region after the proton pulse, as illustrated in FIG. 11. The gamma-ray yield, however, disappears in targets with the polyethylene shielding with loaded boron. It is believed that fast spallation neutrons produced by the proton flash undergo fast multiplication as they traverse fissionable material in the target. The fast spallation occurs in all materials whose fission threshold is above 1.5 MeV, such as ²³⁸U. When a fraction of the neutrons are thermalized in the surrounding media, gamma-ray yield in the polyethylene is increased. Whereas, the thermal neutrons in the boron loaded polyethylene are absorbed so that the gamma-ray yield is reduced in the 200-500 μs time region. As illustrated in FIG. 11, in the 100-500 μs region the photomultiplier gain significantly recovers, but the high rate pulses pile up and create a baseline shift proportional to the gamma-ray energy multiplied by gamma-ray rate. This creates a current on the 50Ω resistor of the digitizer. To verify the experimental data and the underlying principle, Monte Carlo (MCNPX) calculations were performed and shown as solid and dashed lines in FIG. 11. MCNPX code is described in MCNPX User's Manual, LANL Report, LA-CP-07-1473, (2008)

### Example 5

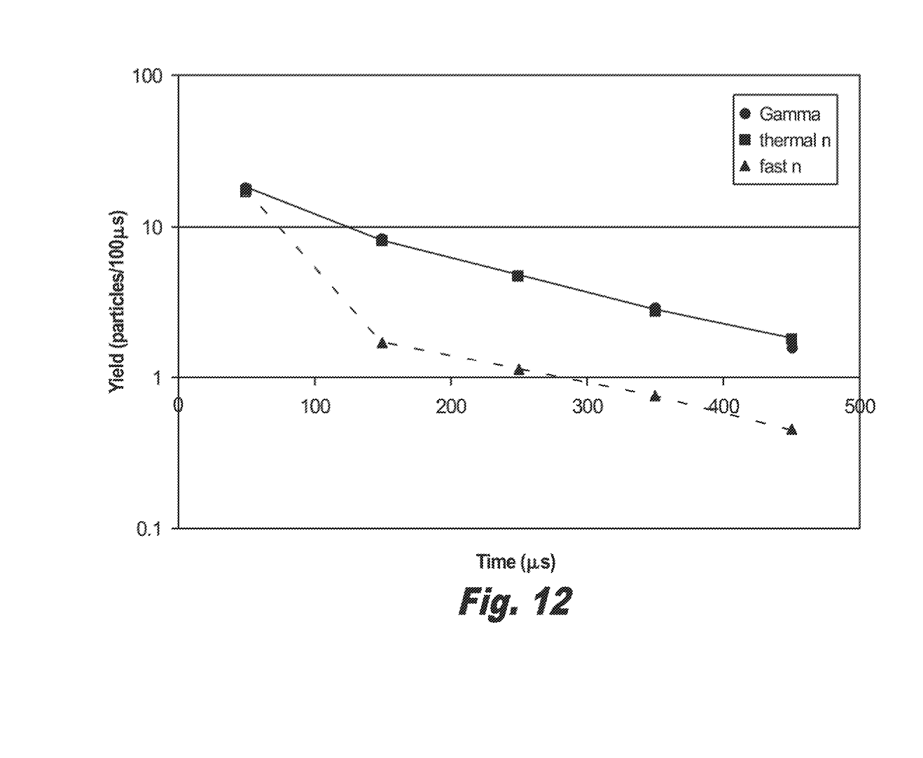

This example provides Monte Carlo calculations for fast and thermal neutron yields, as a function of time, in the shielded highly enriched uranium. In the initial model calculations the time evolution of the system after a fission event was investigated for 2 MeV fission neutrons. To realize this scenario a 2 MeV neutron source was placed in 20 kg ^{235/238}U and the resulting neutron and gamma-flux were tallied. The yield of fast and thermal neutrons for depleted uranium and highly enriched uranium with and without polyethylene shield were calculated in 100 μs steps. As illustrated in FIG. 12, the Monte Carlo calculations indicate that if the target were highly enriched uranium there would be a distinctive fast neutron yield in the 100-500 μs time region from thermal-neutron-induced fission. The liquid scintillator/photomultiplier detector and high bandwidth data recording system described in Examples 1-3 are capable of recording the fast neutrons. Their pulses can be sorted out from the recorded mixed neutron and gamma-ray pulses in organic scintillator by off line pulse shape discrimination.

### Example 6

As provided in Examples 1-5, the radiation output from a single pulse of 4 GeV protons incident was measured on various targets. The spallation and fission processes produced gamma emitting nuclides indicative of isomeric transitions. The presence of these nuclides was slowly varying with atomic mass, e.g., for iron and nickel, in agreement with many high energy proton measurements (P. Kozma and J. Kliman, J. Phys. G: Nucl. Part. Phys. 16 (1990), p. 45; incorporated herein by reference in its entirety). Typically, in high energy proton measurements, the charge distribution of spallation products was found to have a maximum close to the unchanged charge distribution quantity of the nuclear collision, (Z+1)/(A+1). However, ²³⁵U and ²³⁸U products had the highest energy photon production of the nuclides in the tested target set.

Furthermore, a large gamma-ray signal was detected in the presence of an efficient thermalizing material, e.g., polyethylene. Monte Carlo calculations suggest that the large gamma-ray signal yield is from thermal neutron capture. The data further suggest that thermal neutron fission in ²³⁵U would produce high energy neutrons that would unequivocally differentiate highly enriched uranium from the depleted uranium on the basis of spectra. Thus, useful signatures can be obtained from moderated highly enriched uranium in a time window close to the prompt signal of the excitation pulse using high energy proton irradiation.

All publications and patents mentioned in the above specification are herein incorporated by reference in their entireties. Various modifications and variations of the described materials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching herein and no more than routine experimentation, many equivalents to the specific embodiments of the invention described herein. Such equivalents are intended to be encompassed by the following claims.

1. A method for detecting and identifying special nuclear materials, the method comprising:
(i) exposing a target to a high intensity particle or photon beam pulse to induce fission;
(ii) detecting emission of prompt and delayed radiation from the target using a detection system, wherein the radiation comprises fast and thermal neutrons;
(iii) recording fast neutrons induced by thermal neutron fission and gamma-rays from thermal neutron induced fission;
(iv) analyzing a die away in the fast neutron yield induced by thermal neutron fission of the target; and
(iv) comparing the fast neutron yield from the target to the fast neutron yield characteristic for a special nuclear material;
wherein a close correlation of the fast neutron die away indicates the presence of the special nuclear material within the target.

2. The method according to claim 1, further comprising recording from fission isomeric transitions to monitor fission of the target.

3. The method according to claim 1, further comprising recording inelastic scattering and capture gamma-rays from neutron interactions with bulk media as a reference.

4. The method according to claim 1, wherein the detection system comprises a scintillator, a photomultiplier operating in a low-gain mode optically coupled to the scintillator, and fast digitizer connected to the photomultiplier.

5. The method according to claim 1, wherein the detection of prompt and delayed radiation comprises the detection of prompt neutrons from the fission decay of the target within the first microsecond by time of flight.

6. The method according to claim 1, wherein the die away yield of fast neutrons are recorded in the 100-500 μs is time region after the induced fission.

7. The method according to claim 1, wherein the digitizer has bandwidth between about 100 MHz and about 600 Mhz.

8. The method according to claim 1, wherein the high intensity particle beam pulse is a single proton pulse of duration less than 100 ns that contains at least 10¹¹ protons.

9. The method according to claim 1, wherein the high intensity particle beam pulse has a power range between about 0.3 GeV and 10 GeV.

10. The method according to claim 1, further comprising separating and monitoring the fast neutron yield from recorded mixed neutron and gamma-ray pulses by off-line pulse shape discrimination.

11. The method according to claim 1, wherein the special nuclear material is highly enriched uranium (^{235/238}U).

12. The method according to claim 1, wherein the special nuclear material is uranium.

13. The method according to claim 1, wherein the gain of the photomultiplier is set to be about 10⁻³ of normal high gain.

14. The method according to claim 1, wherein the count rate of the detection system is between about 10⁵ and about 10⁹ counts/s.

15. The method according to claim 14, wherein the count rate of the detection system is 10⁷ counts/s.

16. The method according to claim 1, wherein the distance between the target and the detection system is between 10 m and 100 m.

17. The method according to claim 1, wherein the target is shielded by a neutron and gamma-ray shielding material.

18. The method according to claim 1, wherein the neutron and gamma-ray shielding material is polyethylene or polyethylene loaded with boron.

19. The method according to claim 1, further comprising monitoring gamma-ray spectra for isomeric transition region, analyzing the gamma-ray spectra by placing 100 ms wide time windows, and extracting a pulse height distribution within each window, wherein the special nuclear material has the highest gamma-ray energy in a distinct Compton edge profile.

20. The method according to claim 1, wherein the high intensity particle beam is generated by high energy proton source, photon (bremsstrahlung) source, or any other similar source known to induce neutron fission.

21. A system for identification of special nuclear materials, comprising:
a high intensity particle or photon beam source sufficient to induce thermal-neutron-fission in a target, and a detection system that comprises
a scintillator; and
a photomultiplier optically coupled to the scintillator; and
a recording system coupled to the photomultiplier to record the signal;
wherein the photomultiplier operates in a low-gain mode, and the recording system processes the neutron yield in the 100-500 μs time region from thermal-neutron-induced fission.

22. The system according to claim 21, wherein the recording system has bandwidth between about 100 MHz and about 600 Mhz.

23. The system according to claim 21, wherein the high intensity particle beam pulse is a single proton pulse of duration less than 100 ns that contains at least 10¹¹ protons.

24. The system according to claim 21, wherein the high intensity particle beam pulse has a power range between about 0.3 GeV and 10 GeV.

25. The system according to claim 21, wherein the special nuclear material is highly enriched uranium (^{235/238}U).

26. The system according to claim 21, wherein the gain of the photomultiplier is set to be about 10⁻³ of normal high gain.

27. The system according to claim 21, wherein the count rate of the detection system is between about 10⁵ and about 10⁹ counts/s.

28. The system according to claim 27, wherein the count rate of the detection system is 10⁷ counts/s.

29. A detection system comprising:
a scintillator; and
a photomultiplier optically coupled to the scintillator; and
a recording system coupled to the photomultiplier to record the signal;
wherein the photomultiplier operates in a low-gain mode, and the recording system processes the neutron yield in the 100-500 μs time region from thermal-neutron-induced fission.

30. The detection system of claim 18, wherein the recording system comprises a high bandwidth digitizer.

31. The detection system of claim 18, wherein the scintillator is a liquid organic scintillator.

32. The detection system of claim 18, wherein the scintillator has a rise time of less than 2 ns and an exponential decay constant of 2-20 ns.

33. The detection system of claim 18, wherein the photomultiplier is sufficiently fast photomultiplier capable of count rate recording between about 10⁵ and about 10⁹ counts/s.

34. The detection system of claim 18, wherein the photomultiplier operates within about 1/1000 of the high gain limit.

35. The detection system of claim 18, wherein the photomultiplier operates within the gain sufficiently low to allow inter-dynode charge to be replaced between particles.

36. The detection system of claim 18, wherein the neutron yield is calculates as a function of time-of-flight signal.

37. The detection system of claim 20, wherein the recording bandwidth of the digitizer is greater than 100 MHz.

38. A low-gain photomultiplier comprising
an enclosing;
a window within the enclosing to allow the passage of incoming photons;
a photocathode near the window that absorbs photons and releases electrons;
an anode positioned near the opposite end of the enclosing away from the photocathode;
a plurality of dynodes positioned between the photocathode and the anode that multiply the number of electrons emitted from the photocathode before they reach the anode;
a power supply connected to the plurality of dynodes via a plurality of voltage dropping resistors to facilitate electron multiplication in the dynodes; and
a plurality of capacitors operably linked to one or more dynodes to remove a transient signal in order to lower the photomultiplier gain that arrives at the anode.

39. The low-gain photomultiplier of claim 38, wherein the removal of transient signal lowers the photomultiplier gain on the order of about 1/1000 of the high gain limit.
